(19) United States
(12) Patent Application Publication
(10) Pub. No.: US 2015/0328696 A1
(43) Pub. Date: Nov. 19, 2015

(54) Boring Cutter

(71) Applicant: ZHUZHOU CEMENTED CARBIDE CUTTING TOOLS CO., LTD., Zhuzhou, Hunan (CN)

(72) Inventors: Shequan WANG, Zhuzhou (CN); Aisheng JIANG, Zhuzhou (CN); Aimin TANG, Zhuzhou (CN); Min LIU, Zhuzhou (CN)

(21) Appl. No.: 14/653,270

(22) PCT Filed: Sep. 30, 2013
(86) PCT No.: PCT/CN2013/084784

§ 371 Date: Jun. 18, 2015

(30) Foreign Application Priority Data
Jun. 28, 2013 (CN) 201310266451.5

(51) Int. Cl. B23B 51/06; B23B 51/02

(52) U.S. Cl. CPC B23B 51/06; B23B 51/02; B23B 2250/12; B23B 2250/16; B23B 2251/50

(57) ABSTRACT

A boring cutter includes a tool body and a cutting insert. The tool body includes a shaft handle and a cutting end, and defines a circumferential face extended between the shaft handle and the cutting end. The tool body further has an insert pocket extended to the cutting end to secure the cutting insert at the insert pocket, and a flute formed on the circumferential face to communicate with the insert pocket. The tool body further has a cooling channel extended through the shaft handle to the cutting end, and a plurality of discharging chambers spacedly formed on the circumferential face to communicate with the cooling channel. During a drilling process, cooling fluid is released to the discharging chambers from the cooling channel to create a pressure between the tool body and an inner wall of a hole of a workpiece to prevent the tool deflection and drilling vibration.

### CROSS REFERENCE OF RELATED APPLICATION

This is a non-provisional application that claims priority to international application number PCT/CN2013/084784, international filing date Sep. 30, 2013, which claims priority to Chinese application number 201310266451.5, filing date Jun. 28, 2013.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of the Invention

The present invention relates to a tool, and more particular to a boring cutter which has a relatively large diameter size, an anti-vibration ability, and a high precision drilling structure.

2. Description of Related Arts

A drilling tool generally comprises a rear fitting shaft, a front cutting head, a plurality of cutting edges extended at the cutting head, and a plurality of grooves or flutes extended at the cutting head adjacent to the flutes. During operation, the cutting head of the drilling tool is driven to rotate in order to apply a rotational cutting force at the cutting edges for making a hole or bore on a workpiece. The flutes are arranged to vent the debris generated during the drilling process from the hole being formed by the cutting edges. At the same time, the vibration is generated at a cutting end of the drilling tool is greater than that at the fitting portion, so as to cause the drilling related problems, such as the deflection of the drilling tool and drilling inefficiency. Furthermore, in order to efficiently vent the debris during the drilling process, the size of each flute will be enlarged. In other words, a diameter ratio between a core portion of the cutting head and the cutting edge will be minimized. As a result, the vibration at the cutting head will be increased to cause serious deflection of the drilling tool during the drilling process. Especially when the length of the cutting head is prolonged, the vibration at the cutting end thereof will be correspondingly increased. The drilling vibration is an important cause of premature failure of the cutting edge, low precision of hole making, and damage of workpiece surface. In severe cases, the cutting head can be broken during the drilling process. Therefore, the conventional drilling tool is designed to make a smaller hole on the workpiece in low surface quality.

### SUMMARY OF THE PRESENT INVENTION

The invention is advantageous in that it provides a boring cutter, which has a simple structural configuration and can minimize the vibration of the cutting head during the drilling process, so as to ensure the quality of the hole especially for the lengthened cutting head.

Additional advantages and features of the invention will become apparent from the description which follows, and may be realized by means of the instrumentalities and combinations particular point out in the appended claims.

According to the present invention, the foregoing and other objects and advantages are attained by a boring cutter which comprises a tool body and a cutting insert. The tool body comprises a shaft handle and a cutting end, and defines a circumferential face extended between the shaft handle and the cutting end. The tool body further has at least an insert pocket extending to the cutting end in a helical manner and at least a flute formed on the circumferential face to communicate with the insert pocket. The tool body further has a cooling channel extended through the shaft handle to the cutting end, a plurality of discharging chambers spacedly formed on the circumferential face to communicate with the cooling channel, and a plurality of fluid guiding grooves extended to communicate the cooling channel with the discharging chambers respectively.

The discharging chambers are radially formed on the circumferential face of the tool body, wherein the discharging chambers are located and orientated on the circumferential face from the shaft handle to the cutting end in a helical manner. The flutes have the same helical angles along an axial direction of the tool body. The sizes of the discharging chambers are orderly increased from the shaft handle to the cutting end of the tool body.

The fluid guiding grooves are radially extended from the cooling channel to bottom walls of the discharging chambers at centers thereof respectively.

The centerlines of the fluid guiding grooves are perpendicular to a rotational axis of the tool body.

The cutting insert has an outer cutting face and an inner cutting face, wherein the outer cutting face of the cutting insert is located adjacent to the circumferential face while the inner cutting face of the cutting insert is located close to the rotational axis of the tool body.

Another advantage of the invention is to provide a boring cutter, wherein the discharging chambers are radially formed on the circumferential face of the tool body to communicate with the cooling channel via the fluid guiding grooves respectively. Therefore, during the drilling process, the cooling fluid is discharged from the cooling channel to the discharging chambers through the fluid guiding grooves respectively. The cooling fluid is then discharged at a gap between the tool body and the inner wall of the hole to form a dynamic cooling guidance, which can controllably adjust a pressure around the circumferential face of the tool body to minimize the tool deflection and drilling vibration. As a result, when drilling a deep hole, the cooling fluid can be discharged along the circumference face of the tool body to prevent the tool deflection and drilling vibration due to the lengthened cutting end, especially for drilling the hole with a relatively large diameter. In addition, the cooling fluid can effectively cool down the tool body during the drilling process to minimize the heat generated therefrom so as to prolong the service life span of the drilling tool.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a boring cutter according to a first preferred embodiment of the present invention.

FIG. 2 is a side view of the boring cutter according to the above first preferred embodiment of the present invention.

FIG. 3 is an elongated perspective view of the boring cutter according to the above first preferred embodiment of the present invention.

FIG. 4 is a perspective view of a boring cutter according to a second preferred embodiment of the present invention.

FIG. 5 is a side view of the boring cutter according to the above second preferred embodiment of the present invention.

FIG. 6 is an elongated perspective view of the boring cutter according to the above second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

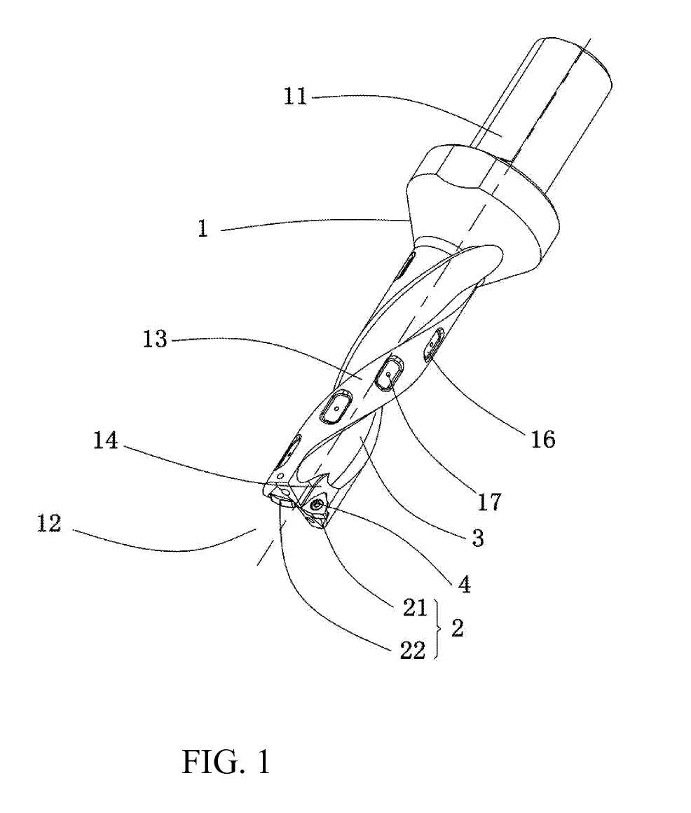

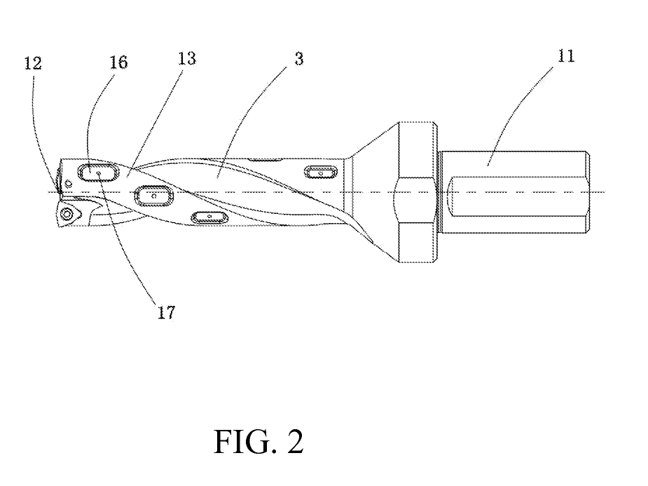

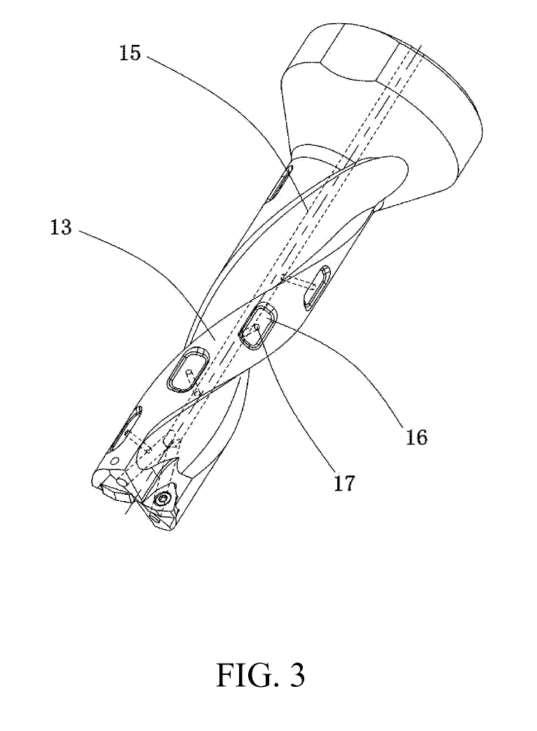

Referring to FIGS. 1 to 3, a boring cutter according to a preferred embodiment of the present invention is illustrated, wherein the boring cutter comprises a tool body 1, at least a cutting insert 2, and at least a fastener 4. The tool body 1 comprises a shaft handle 11 and a cutting end 12, and defines a circumferential face 13 extended between the shaft handle 11 and the cutting end 12. The tool body 1 further has at least an insert pocket 14 extending to the cutting end 12 in a helical manner and at least a flute 3 formed on the circumferential face 13 to communicate with the insert pocket 14, wherein the cutting insert 2 is affixed at the insert pocket 14 via the fastener 4. The tool body 1 further has a cooling channel 15 extended through the shaft handle 11 to the cutting end 12, and a plurality of discharging chambers 16 spacedly formed on the circumferential face 13 to communicate with the cooling channel 15. Preferably, the cooling channel 15 is coaxially extended through the shaft handle 11 to the cutting end 12. Accordingly, during the drilling process, a cooling fluid is released to the cooling channel 15 and is discharged at the discharging chambers 16. Therefore, when the tool body 1 is rotated to drill a hole on a workpiece at the cutting end 12, the cooling fluid is discharged at a gap between the tool body 1 and the inner wall of the hole to form a dynamic cooling guidance, which can controllably adjust a pressure around the circumferential face 13 of the tool body 1 to minimize the tool deflection and drilling vibration. As a result, when drilling a deep hole, the cooling fluid can be discharged along the circumference face 13 of the tool body 1 to prevent the tool deflection and drilling vibration due to the lengthened cutting end 12, especially for drilling the hole with a relatively large diameter. In addition, the cooling fluid can effectively cool down the tool body 1 during the drilling process to minimize the heat generated therefrom so as to prolong the service life span of the drilling tool.

According to the preferred embodiment, the discharging chambers 16 are radially formed on the circumferential face 13 of the tool body 1, wherein the discharging chambers 16 are located and orientated on the circumferential face 13 from the shaft handle 11 to the cutting end 12 in a helical manner. The flutes 3 have the same helical angles along an axial direction of the tool body 1. Accordingly, the tool body 1 further has a plurality of fluid guiding grooves 17 radially extended from the cooling channel 15 to bottom walls of the discharging chambers 16 respectively. Preferably, the bottom wall of the discharging chamber 16 is a flat surface. A diameter size of the fluid guiding groove 17 is smaller than a size of the discharging chamber 16, wherein the size of the discharging chamber 16 is gradually increased from the bottom wall to the circumferential face 13 of the tool body 1. In particular, the sizes of the discharging chambers 16 are orderly increased from the shaft handle 11 to the cutting end 12 of the tool body 1, such that the discharging chambers 16 have different sizes with respect to the locations thereof. In other words, the size of the discharging chamber 16 close to the cutting end 12 of the tool body 1 is larger than the size of the discharging chamber 16 at the shaft handle 11 of the tool body 1 to ensure the pressure around the cutting end of the tool body 1 is larger than the pressure away from the cutting end of the tool body 1, so as to prevent the tool deflection and to offset the less rigidity of the tool body 1 at the cutting end thereof. Accordingly, an exit end area of the fluid guiding groove 17 is smaller than a surface area of the bottom wall of the discharging chamber 16, wherein the fluid guiding grooves 17 are extended to the centers of the discharging chambers 16 respectively to ensure the cooling fluid to be evenly distributed at the discharging chambers 16, so as to ensure the pressure to be evenly applied at the tool body 1 and to stably rotate the tool body 1. The centerlines of the fluid guiding grooves 17 are perpendicular to the rotational axis of the tool body 1 to ensure the rigidity of the tool body 1 at the circumferential face 13 thereof.

According to the preferred embodiment, the cutting insert 2 has an outer cutting face 21 and an inner cutting face 22, wherein the outer cutting face 21 of the cutting insert 2 is located adjacent to the circumferential face 13 while the inner cutting face 22 of the cutting insert 2 is located close to the rotational axis of the tool body 1.

According to the preferred embodiment, the tool body 1 has two circumferential faces 13 spacedly extending in a helix manner, wherein the discharging chambers 16 are symmetrically located on the circumferential faces 13 along the rotational axis of the tool body 1 so as to ensure the cutting force thereof to evenly apply at the workpiece.

During the drilling process, a portion of the cooling fluid is discharged to a drilling zone of the workpiece through the cooling channel 15 while a portion of the cooling fluid is discharged from the cooling channel 15 to the discharging chambers 16 through the fluid guiding grooves 17 respectively. Accordingly, the inner wall of hole will seal most of the cooling fluid within the discharging chambers 16. A relatively small portion of the cooling fluid will fill at the gap between the inner wall of the hole and the circumferential surface 13 of the tool body 1 to create the pressure therearound. It is worth mentioning that the pressure is evenly and symmetrically applied around the tool body 1 with respect to the distribution of the discharging chambers 16 on the circumferential surface 13 and with respect to the rotational axis of the tool body 1. The amount of pressure at the discharging chamber 16 is selectively adjusted depending on the discharging pressure of the cooling fluid, the area of the discharging chamber 16, and the gap size between the inner wall of the hole and the circumferential surface 13 of the tool body 1. Assuming the discharging pressure of the cooling fluid and the area of the discharging chamber 16 are constant, the pressure at the discharging chamber 16 will be increased when the gap size is reduced. When there is a vibration at the tool body 1, the cooling fluid at the discharging chambers 16 will from an anti-vibration cutting torque to absorb and reduce the vibration. The anti-vibration cutting torque can be large enough to eliminate the vibration of the tool body 1, so as to enhance the drilling operation of the tool body 1 and to prevent the tool body 1 from being broken by the vibration. Since the cooling fluid dynamically flows between the inner wall of the hole and the circumferential surface 13 of the tool body 1 to create the pressure therearound, the cooling fluid further serves as a lubricant to minimize a friction between the inner wall of the hole and the circumferential surface 13 of the tool body 1. Furthermore, the pressure at the discharging chambers 16 can be controllably adjusted to prevent the offset of the cutting end 12 along the rotational axis of the tool body 1 so as to prevent the tool deflection. As a result, the drilling tool of the present invention can make a hole in a desired axial and radial dimension.

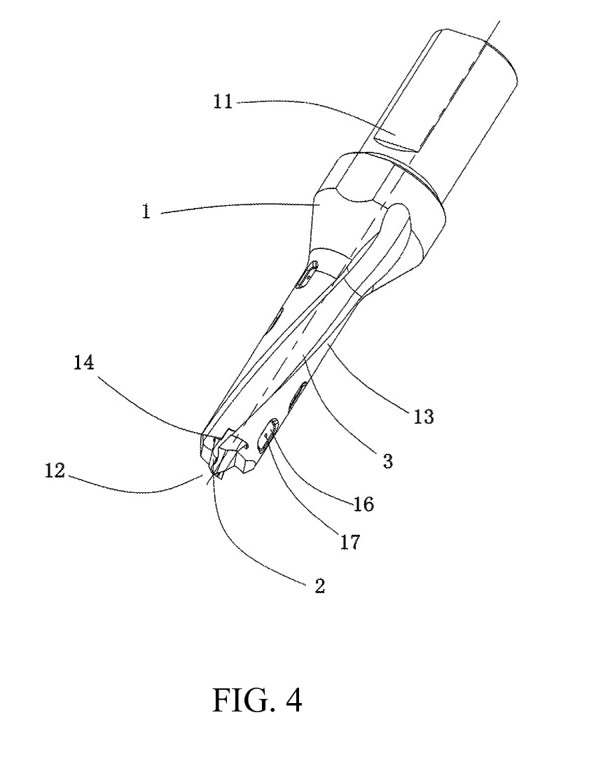

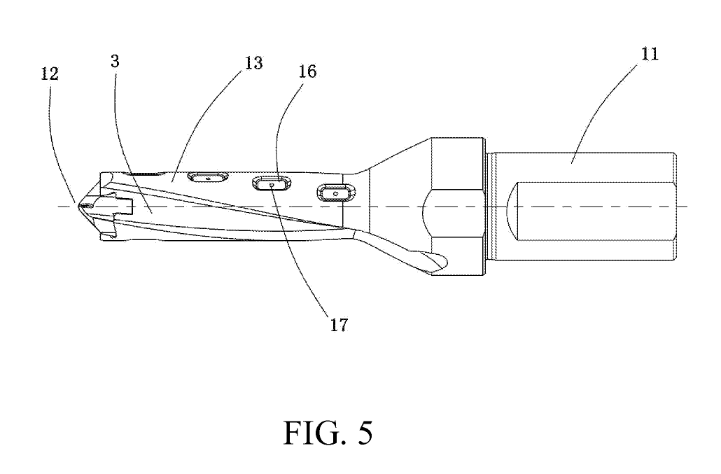

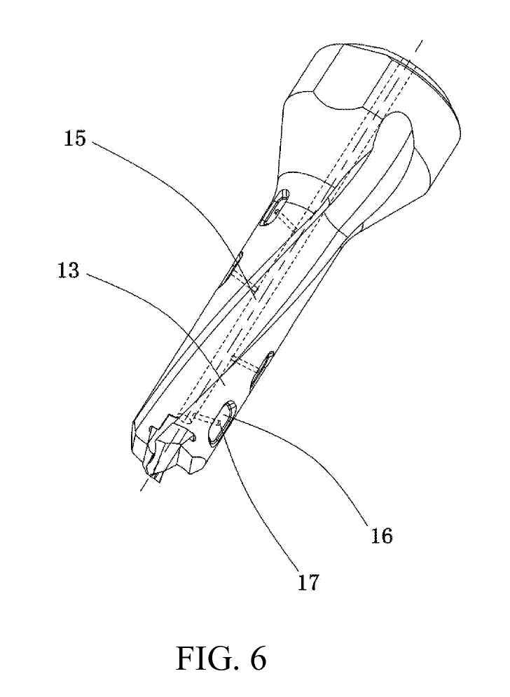

FIGS. 4 to 6 illustrate an alternative mode of the cutting insert 2, wherein the cutting insert 2 is affixed at the insert pocket 14 by means of the elasticity of the insert pocket without any fastener. It is appreciated that the cutting insert 2 can be integrated at the insert pocket 14.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A boring cutter for drilling a hole on a workpiece, comprising a tool body and a cutting insert, wherein said tool body comprises a shaft handle and a cutting end, and defines a circumferential face extended between said shaft handle and said cutting end;
wherein said tool body further has an insert pocket extended to said cutting end to secure said cutting insert at said insert pocket, and a flute formed on said circumferential face to communicate with said insert pocket;
wherein said tool body further has a cooling channel extended through said shaft handle to said cutting end, a plurality of discharging chambers spacedly formed on said circumferential face to communicate with said cooling channel, and a plurality of fluid guiding grooves extended from said cooling channel to said discharging chambers respectively.

2. The boring cutter, as recited in claim 1, wherein said discharging chambers are radially formed on said circumferential face of the tool body, wherein said discharging chambers are located and orientated on said circumferential face from said shaft handle to said cutting end in a helical manner, wherein said flutes have the same helical angles along an axial direction of said tool body.

3. The boring cutter, as recited in claim 1, wherein sizes of said discharging chambers are orderly increased from said shaft handle to said cutting end of said tool body.

4. The boring cutter, as recited in claim 1, wherein said fluid guiding grooves are radially extended from said cooling channel to bottom walls of said discharging chambers at centers thereof respectively.

5. The boring cutter, as recited in claim 3, wherein said fluid guiding grooves are radially extended from said cooling channel to bottom walls of said discharging chambers at centers thereof respectively.

6. The boring cutter, as recited in claim 1, wherein centerlines of said fluid guiding grooves are perpendicular to a rotational axis of said tool body.

7. The boring cutter, as recited in claim 3, wherein centerlines of said fluid guiding grooves are perpendicular to a rotational axis of said tool body.

8. The boring cutter, as recited in claim 1, wherein said cutting insert has an outer cutting face and an inner cutting face, wherein said outer cutting face of said cutting insert is located adjacent to said circumferential face while said inner cutting face of said cutting insert is located close to a rotational axis of said tool body.

9. The boring cutter, as recited in claim 7, wherein said cutting insert has an outer cutting face and an inner cutting face, wherein said outer cutting face of said cutting insert is located adjacent to said circumferential face while said inner cutting face of said cutting insert is located close to said rotational axis of said tool body.

10. The boring cutter, as recited in claim 2, wherein sizes of said discharging chambers are orderly increased from said shaft handle to said cutting end of said tool body.

11. The boring cutter, as recited in claim 10, wherein said fluid guiding grooves are radially extended from said cooling channel to bottom walls of said discharging chambers at centers thereof respectively.

12. The boring cutter, as recited in claim 10, wherein centerlines of said fluid guiding grooves are perpendicular to a rotational axis of said tool body.

13. The boring cutter, as recited in claim 12, wherein said cutting insert has an outer cutting face and an inner cutting face, wherein said outer cutting face of said cutting insert is located adjacent to said circumferential face while said inner cutting face of said cutting insert is located close to said rotational axis of said tool body.

14. The boring cutter, as recited in claim 2, wherein said fluid guiding grooves are radially extended from said cooling channel to bottom walls of said discharging chambers at centers thereof respectively.

15. The boring cutter, as recited in claim 2, wherein centerlines of said fluid guiding grooves are perpendicular to a rotational axis of said tool body.

16. The boring cutter, as recited in claim 2, wherein said cutting insert has an outer cutting face and an inner cutting face, wherein said outer cutting face of said cutting insert is located adjacent to said circumferential face while said inner cutting face of said cutting insert is located close to a rotational axis of said tool body.
